(19) United States
(12) Patent Application Publication
(10) Pub. No.: US 2015/0306747 A1
(43) Pub. Date: Oct. 29, 2015

(54) Screw driving device for recognizing screwing accessories in the coaxial position

(71) Applicant: ETABLISSEMENTS GEORGES RENAULT, Saint Herblain (FR)

(72) Inventors: Florian Theureaux, Nantes (FR); Benoit Abrassard, Nantes (FR)

(21) Appl. No.: 14/697,179

(22) Filed: Apr. 27, 2015

(30) Foreign Application Priority Data
Apr. 25, 2014 (FR) 1453750

(51) Int. Cl. B25B 21/00; B25B 23/147

(52) U.S. Cl. CPC B25B 21/00; B25B 23/147

(57) ABSTRACT

A screw driving system including: a screw driving device having a body to which there is mounted an output shaft so as to be mobile in rotation, the body housing a motor connected to the output shaft by a transmission; at least one screwing accessory cooperating with the output shaft to be driven in rotation; a reversible attachment for the screwing accessory; and elements for recognizing the accessory when it is fixedly attached to the device via the reversible attachment. The elements for recognizing include an electronic tag reader attached to the device and an electronic tag fixedly attached to the accessory, the reader and the tag being positioned, when the accessory is fixedly attached to the device, in the axis of the output shaft, the reader being connected by a power supply and/or data transmission wire, the wire extending in the device in the axis of the output shaft.

### CROSS-REFERENCE TO RELATED APPLICATIONS

This Application claims priority from French Patent Application No. 1453750, filed Apr. 25, 2014, the content of which is incorporated herein by reference in its entirety.

### FIELD OF THE DISCLOSURE

The field of the disclosure is that of the designing and manufacture of screw driving devices, commonly called screwdrivers, especially portable devices of this kind.

### PRIOR ART

Portable screwdrivers are commonly used especially in the aeronautics and automobile industries to tighten structural assemblies.

The tightening of such assemblies generally has to be done reliably, i.e. with a high level of precision.

To meet this requirement, automatically controlled screwdrivers have been developed. Screwdrivers of this type comprise means for measuring the tightening torque and/or the angle of tightening of the screws. They are generally driven through a command means used to program different screw driving strategies, especially as a function of the size of the screws, the elasticity of the assembly, the desired precision in the tension installed in the assembly due to the tightening, etc.

A screw driving strategy consists of a set of parameters defining the behavior that the screwdriver must have during a screw driving operation. These parameters can relate to the goals to be achieved in terms of tightening (a certain level of tightening torque or tightening angle) as well as the way to achieve these goals: the motor is driven at a given level of rotation frequency until a first level of tightening torque is achieved during the screwing-in phase during which the screw head approaches the parts to be assembled, and then at another level of rotation frequency during the screwing-in phase during which the tightening torque increases, until the targeted tightening torque has been reached.

On an assembly line, an operator generally has to screw in screws of different sizes which therefore require different screw driving strategies. The screws to be tightened also often have different shapes, and this implies the use of different sockets. In addition, certain screws can be situated in congested surroundings and therefore be relatively difficult to reach. It may then be necessary to use a crowfoot unit in order proceed to tightening.

An operator therefore generally has to change screw driving accessories (sockets, crowfoot units, etc) while he sequences the tightening of different elements and also accordingly selects the adapted screwing-in strategy in the command means.

These changes of screw driving accessories and selection of screw driving strategies leads to loss of time and a risk of error.

To overcome these drawbacks, sockets cases have been developed. These sockets cases comprise a receptacle housing a plurality of sockets and crowfoot units and integrating a presence sensor for each of these accessories. This sockets case is connected by command means to a screwdriver in such a way that the presence of an accessory is no longer detected in the box, which means that it is fixedly attached to the screwdriver in order to screw in a given element. Then the corresponding screwing-in strategy is automatically activated.

The use of such sockets cases secures the selection of the screwdriver strategy adapted to the screw driving accessory used and the corresponding assembly. These cases however have the drawback of being fairly impractical for use because of their substantial volume and the cable that connects them to the screwdriver especially in narrow and/or congested work spaces.

To overcome the drawbacks inherent in the use of sockets cases, it has been thought to equip the sockets with an electronic tag and the screwdrivers with an electronic tag reader. Thus, when a screw driving accessory is fixed to the screwdriver, the command means read the information on the tag by means of the reader and selecting the corresponding screw driving strategy.

This technical solution does not have the drawbacks of sockets cases in terms of practicality of use. They nevertheless have some drawbacks.

The means for fixedly attaching the screw driving accessories to the screwdrivers of this type do not allow for attaching different types of accessories to these screwdrivers. They are designed only to enable the attachment of different sockets or of different driving recess to the screwdriver. They do not however make it possible to attach to these same screwdrivers, for example, different sockets at certain times and different crowfoot units at other times.

Another drawback of this approach is that the electronic tags and sometimes the associated reader are placed on the periphery and/or on the surface of the accessory or of the screwdriver so much so that they are always exposed to impacts with the external environment when they are being handled and when the screwdriver is being handled.

### SUMMARY

An exemplary aspect of the present disclosure relates to a screw driving system comprising:
a screw driving device comprising a body at one end of which there is mounted an output shaft mounted so as to be mobile in rotation, said body housing a motor connected to said output shaft by means of a transmission,
at least one screw driving accessory intended to cooperate with said output shaft to be driven in rotation,
at least one reversible attachment means for the reversible attachment of said at least one screw driving accessory to said screw driving device, means for recognizing said accessory when it is fixedly attached to said device via the reversible attachment means, said means for recognizing comprising an electronic tag reader fixedly attached to said device and an electronic tag fixedly attached to said accessory, said reader and said tag being positioned, when said accessory is fixedly attached to said device, in the axis of said output shaft, said reader being connected by at least one power supply and/or data transmission wire, said at least one wire extending in said device in the axis of said output shaft.

Thus, the technique discussed proposes an original solution which consists in placing the electronic tag reader and the electronic tag, when the accessory to which it is fixedly attached is attached to the screwdriver, in the axis of the junction between the screwdriver and the accessory.

Thus, both the electronic tag and the tag reader are isolated from the exterior, and this contributes to protecting them against impacts with the surroundings. This also offers the possibility of fixedly attaching the screwdriver to accessories of different types such as for example sockets and crowfoot units. This improves the ergonomical aspect.

According to one advantageous characteristic, said body comprises a first body portion housing said motor and a second body portion housing said output shaft, said second body portion being traversed by at least one hole inside which there passes said at least one wire, said body and said hole being configured to enable said wire to extend outside said body along said first body portion.

It is thus possible, by means of an electric wire, to connect the electronic tag reader with the electronic control card of the screw driving device. The wire will naturally be preferably protected against crushing by a casing, allowing this wire to link up to the electronic control card of the screw driving device situated in its handle.

According to one advantageous characteristic, said transmission comprises at least one first pinion gear and one second pinion gear engaged with each other, said second pinion gear being rotationally linked with said output shaft, said at least one wire extending through said second pinion gear.

It is thus possible to place the wire in the axis of the junction between the screw driving device and the screw driving accessory in making it pass through the second pinion gear.

According to one advantageous characteristic, said first and second pinion gears belong to the group comprising:
conical or bevel type pinion gears;
parallel type pinion gears.

The screw driving device can thus be of the angular gear type in which the axis of the output shaft forms a non-zero angle with the axis of the motor or of the crowfoot type in which the axis of the output shaft extends in parallel to the axis of the motor.

According to one advantageous characteristic, said device comprises a pin extending along the axis of rotation of said second pinion gear and passing through it, said pin being crossed by a passage inside which said at least one wire extends.

It is thus possible to place the wire in the axis of the junction between the screw driving device and the screw driving accessory in making it pass through the passage made through this axis. The wire is thus protected.

According to one advantageous characteristic, said pin is fixed relative to said body.

According to one advantageous characteristic, said reader is fixedly attached to said pin.

The fixed pin is an efficient support for the reader.

According to an advantageous characteristic, said output shaft comprises a hollow internal housing capable of receiving a attaching portion of said screw driving accessory, said reader extending on the border of said hollow internal housing in such a way that when said accessory is fixedly attached to said device and said accessory attaching portion is housed inside said hollow internal housing, said tag and said reader face each other.

The quality of the reading by the reader of the content of the electronic tag is thus improved.

According to one advantageous characteristic, said hollow internal housing has a shape complementary to the shape of said attaching portion of said screw driving accessory, said shapes being configured to provide for a rotational link of said output shaft with said screw driving accessory.

It is thus ensured that the screw driving accessory can be driven in rotation by the output shaft.

According to one advantageous characteristic, said fixed reversible attachment means comprise at least:
locking elements mobile between a locked position in which they cooperate with said screw driving accessory or with said device to keep said accessory and said device fixedly attached, and a release position in which they do not cooperate with said screw driving accessory or with said device so that said accessory and said device are no longer kept fixedly attached, and
actuating means for actuating said locking means, said actuating means being mobile between a locking position in which they act on said locking elements to place them in their locked position, and a release position in which said locking elements can take their release position.

It is thus ensured that there is a reversible fixed attachment of the screw driving accessory to the screw driving device that is simple to design and use.

According to one advantageous characteristic, said reversible attachment means comprise:
first means of reversible fixed attachment of a first group of at least one screw driving accessory, and
second means of reversible fixed attachment of a second group of at least one screw driving accessory.

It is thus possible to fixedly attach different screw driving accessories to the screw driving device according to the nature of the screwdriver operation to be performed.

According to one advantageous characteristic, said first and second means of reversible fixed attachment are coaxial.

Thus, a compact device is procured, this compact device nevertheless offering the possibility of fixedly attaching different types of screw driving accessories.

According to a fifth advantageous characteristic, said electronic tag contains information belonging to the following group:
the identifier of said screw driving accessory;
the parameters of the screw driving strategy associated with said screw driving accessory;
data relative to the maintenance of said screw driving accessory;
manufacturer's and/or user's data concerning the screw driving device and/or the screw driving accessory.

The present disclosure relates chiefly to a screw driving device for systems according to any one of the different variants described here above.

The present disclosure also relates to a screw driving accessory for systems according to any one of the variants described here above.

### LIST OF FIGURES

Other features and advantages shall appear from the following description of particular embodiments, given by way of simple illustratory and non-exhaustive examples and from the appended drawings, of which:

FIG. 1 illustrates a view in perspective of a screw driving device according to an exemplary embodiment;

FIG. 2 illustrates a detailed view of a section of the angle head of the screw driving device of FIG. 1;

FIGS. and 3 and 4 respectively illustrate a socket and its fixed attachment to a screwdriver according to an exemplary embodiment;

FIGS. 5 and 6 respectively illustrate a socket with an extension and its fixed attachment to a screwdriver according to an exemplary embodiment;

FIGS. 7 and 8 respectively illustrate a hold-and-drive unit and its fixed attachment to a screwdriver according to an exemplary embodiment;

FIGS. 9 and 10 respectively illustrate a crowfoot unit and its fixed attachment to a screwdriver according to an exemplary embodiment.

### DESCRIPTION OF ONE PARTICULAR EMBODIMENT

6.1. Architecture

6.1.1. Screwdriver

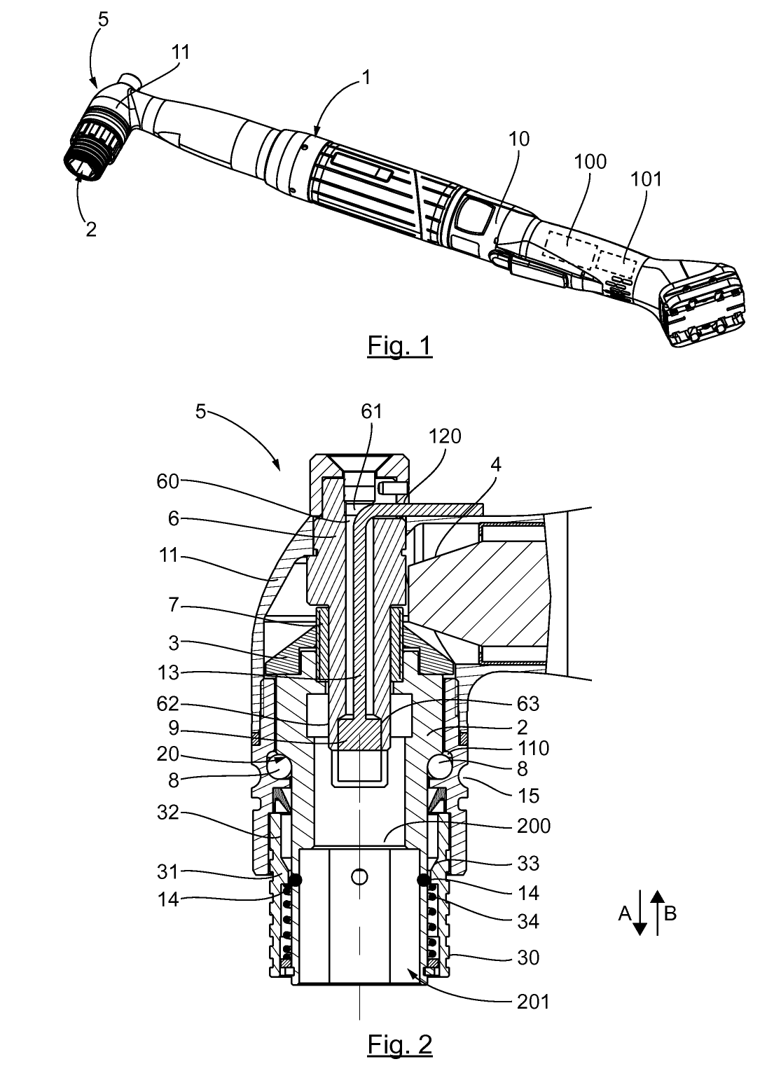

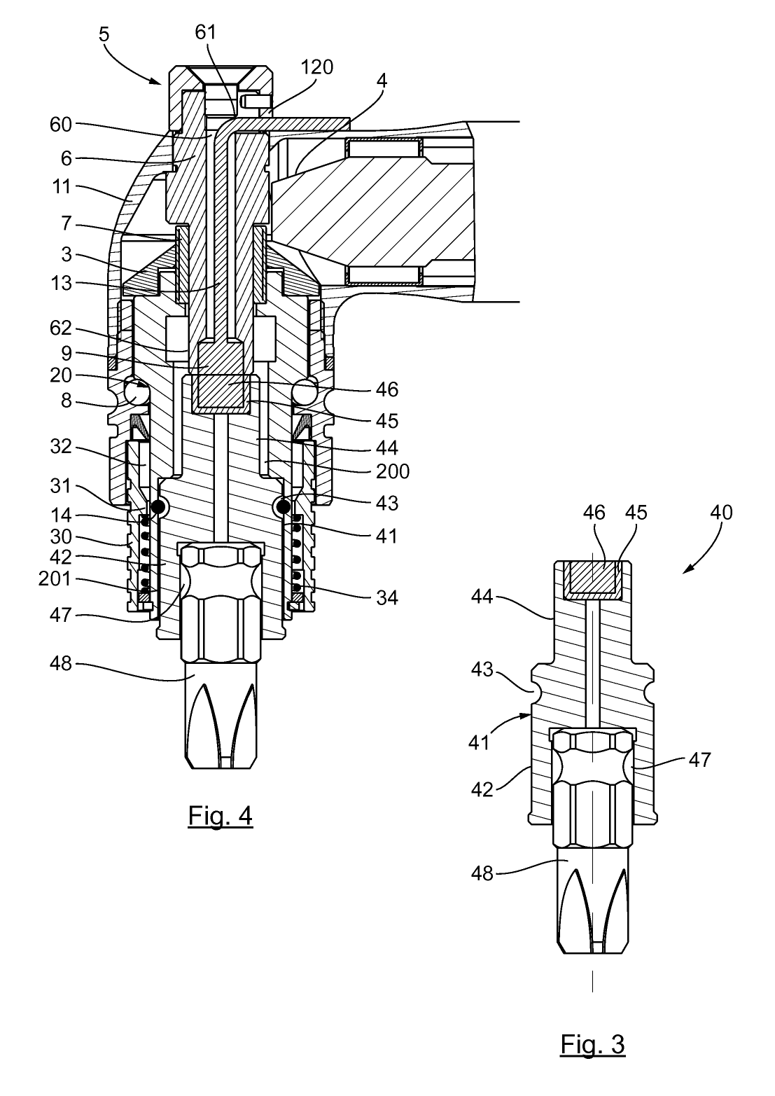

Referring to FIGS. 1 and 2, we present an example of an embodiment of a screw driving device according to an exemplary embodiment.

As shown in these figures, such a screw driving device conventionally comprises a body 1. This body 1 comprises a first portion 10 which houses a motor. In this embodiment, this is an electric motor 100. The body 1 also has a second portion 11 which houses an output shaft 2. As shall be explained in greater detail here below, this shaft 2 is provided to cooperate with a screw driving accessory so as to drive it in rotation.

The body 1 constituted by the two portions 10 and 11 integrates a rotation transmission between the motor 100 and the output shaft 2 in such a way that the end of the shaft 2, opposite that provided to cooperate with a screw driving accessory, is free of any mobile part. The motor is therefore not in the extension of the shaft 2 and said end of the shaft 2 faces the external wall of the portion 11.

Generally, the motor can be either perpendicular to the shaft 2 or parallel and offset relative to the shaft 2.

The driving of the shaft 2 is done by means of the transmission which comprises especially a first pinion gear 4 rotationally driven by the motor and a second pinion gear 3 coaxial with the shaft 2, this second pinion gear 3 cooperating with the first pinion gear 4.

The first pinion gear 4 and second pinion gear 3 can be a pair of bevel pinion gears or a pair of parallel pinion gears.

In the embodiment illustrated in FIGS. 1 and 2, this transmission which is only partially represented, comprises a pair of bevel pinion gears. This pair of bevel pinion gears comprises a first bevel pinion gear 4 which is mounted in the extension of the motor and a second bevel pinion gear 3 which is rotationally linked with the output shaft 2.

In this embodiment, the axis of the first bevel pinion gear 4 forms a right angle with that of the second bevel pinion gear 3. The value of this angle could be different, especially greater than 90%. The end of the body 1 housing the output shaft 2, thus constitutes an angle head 5.

The angle head 5 houses a pin 6 that is fixedly attached inside of the body portion 11. The second bevel pinion gear 3 is mounted so as to be rotationally mobile on the pin 6 by means of a bearing 7.

The end of the body portion 11 comprises an internal peripheral groove 110 with a semi-circular section. The output shaft 2 has an external peripheral groove 20 with a semi-circular section. These grooves 110 and 20 house beads 8. The output shaft 2 is thus guided rotationally relative to the end of the body portion 11 on the one hand by means of the bearing 7 and on the other hand by means of the bearing constituted by the grooves 110, 20 and the beads 8.

The pin 6 is crossed at its centre by a drill hole 60 which extends along its longitudinal axis.

The pin 6 is also crossed by a radial drill hole 61 which opens into the longitudinal drill hole 60. The longitudinal drill hole 60 and the radial drill hole 61 constitute a passage. The radial drill hole 61 communicates with the exterior of the body 1 of the screwdriver, more particularly the zone of the casing or body that houses the pair of pinion gears. The body 1 is crossed for this purpose by a hole 120 which extends in the prolongation of the radial drill hole 61.

The end of the pin 6 oriented towards the output shaft 2 comprises a hexagonal external part 62. It also comprises a housing 63 constituted by a bore hole made inside this pin.

The housing 63 houses an electronic tag reader 9. In this embodiment, this is an RFID chip reader.

The reader 9 is connected to at least one electrical power supply and/or data transmission wire 13.

The output shaft 2 comprises a hollow internal housing 200 capable of receiving an attaching portion of a screw driving accessory. At its end oriented toward the exterior of the body, this hollow internal housing has a hexagonal internal recess 201 that extends along the longitudinal axis of the output shaft 2.

The electrical supply and/or data transmission wire or wires 13 pass through the longitudinal hole 60 and then the radial hole 61 and finally the hole 120.

The hole 120 is configured in such a way that the power supply and/or data transmission wire or wires 13 stretch from the hole 120 along and outside the first body portion 10 housing the motor.

This wire or wires 13 are connected to command unit 101 of the screw driving device. They are protected by a case positioned on the body 1 (not shown).

The screwdriver comprises reversible attachment elements for reversibly attaching screw driving accessories.

These reversible attachment elements are well known in the prior art. Their purpose is to enable the speedy fastening or dismantling of two tool elements.

These two tool elements comprise a male-female type connection interface. The interface can be cylindrical or extruded with a hexagonal section, one of the elements comprising the female part of the interface and the other element comprising the male part.

The male part is kept immobile in translation in the female part by blocking beads attached to the female part, in holes perpendicular to the interface made in the female part, in a position such that the center of the beads is at the interface and goes beyond the interface in a groove in the male part. Thus, an effort to separate the two parts applies shear forces to the beads.

The female element has a locking ring by which the operator can act on the beads to separate these two parts in translating the ring along its axis.

The structure of these reversible attachment elements shall be described in greater detail here below.

Such reversible attachment elements comprise a male part and a female part that are to cooperate with each other. They also comprise:
a ring comprising an internal part with a large diameter and an internal part with a small diameter connected by a truncated conical portion, mounted so as to be mobile in translation between a locking position and a release position, and
beads mounted so as to be mobile between a locking position and a release position,
   the ring and the beads being fixedly attached to the female element.

The small-diameter portion acts, when the ring is in locking position, on the beads so as to place them in their locked position in which they cooperate with a housing of a complementary shape made for this purpose on the male element so that the male and female elements are kept fixedly attached.

When the ring is in release position, the beads are facing the large-diameter portion so that they can occupy their release position in order to enable the coupling and uncoupling of the male and female elements.

In this embodiment, the reversible attachment elements comprise:
first reversible fixed attachment of a first group of at least one screw driving accessory, and
second reversible fixed attachment of a second group of at least one screw driving accessory.

In this embodiment, and as shall be explained in greater detail here below, the first reversible fixed attachment enables the attachment to the screwdriver of the screw driving sockets, extension sockets and the screw “hold and drive” sockets, while the second reversible fixed attachment enables the crowfoot units to be fixedly attached.

The first reversible fixed attachment comprises beads 14 fixedly attached to the output shaft 2. The beads 14 are mounted so as to be mobile inside the output shaft 2 between:
a locked position in which they form protrusions inside the hollow internal housing 200 so as to cooperate, when a screw driving accessory is introduced into the hollow internal housing 206, with an external groove of complementary shape made on the periphery of the attachment portion of the screw driving accessory: the screw driving accessory is then maintained by the beads 14 situated inside the housing 200, and
a release position in which they are at least partly retracted within the peripheral wall of the output shaft 2 so as to enable the beads 14 to be removed from the groove of the screw driving accessory so as to permit the uncoupling of this accessory from the output shaft 2.

The screwdriver comprises an actuator for actuating first reversible fixed attachment. The actuator comprises a first ring 30 which is mounted so as to be mobile in translation along the output shaft 2. This ring 30 comprises an internal large-diameter portion 32 and an internal portion 31 of smaller diameter. These two portions are connected by a truncated conical portion 33. This ring 30 is mobile relative to the output shaft 2 between:
a locking position in which the peripheral wall of the small-diameter portion 31 acts on the beads 14 so as to push them into their locking position in which they form a protrusion inside the hollow internal housing 200 to get housed in the groove provided for this purpose in the screw driving accessory, and
a release position, attained when the ring 30 is translated along the arrow A, in which the small-diameter portion 31 is not situated facing the beads 14, while the wide-diameter portion 32 is situated in the extension of the beads 14 so much so that they can get retracted inside the peripheral wall of the output shaft 2 to occupy their release position in which they no longer cooperate with the groove of the screw driving accessory thus permitting the uncoupling of this accessory.

A compression spring 34 interposed between the ring 30 and the output shaft 2 tends to bring the ring back to its locking position by exerting a recall force on this ring along the arrow B.

The second reversible fixed attachment comprises an external groove 15 with a semi-circular section made on the periphery of the body portion 11. As will be explained in greater detail here below, this groove 15 is capable of housing locking elements fixedly attached to a screw driving accessory.

In both the first and the second reversible fixed attachments, the beads fixedly joined to the female part get housed in a groove made in the male part. This groove is capable of forming a stop in translation between the male and female parts along the axis of the interface.

This means that to have a complete fixed attachment between the two elements, there should be a stop in rotation between these two elements along the axis of the interface. Otherwise, the screw driving accessory can no longer be driven in rotation.

This can be obtained by having a section with a hexagonal interface such as the female recess 201.

6.1.2. Socket

Referring to FIGS. 3 and 4, we present an example of a screw driving socket according to an exemplary embodiment.

Such a screw driving socket 40 comprises an accessory body 41 that is to be housed within the hollow internal housing 200 of the output shaft 2.

This accessory body 41 comprises a first portion whose periphery comprises a male hexagonal part 42 having a shape complementary to the female hexagonal recess 201 made in the output shaft 2. This first portion also has a peripheral external groove 43 with a semi-circular section provided to house the beads 14. This first portion further comprises a hexagonal internal recess 47 which for example can house a screwdriver tip 48 having a portion of a complementary shape.

The first portion is extended by a second portion 42 at the end of which there is a housing 45 that houses an electronic tag such as for example an RFID chip 46. Thus housed in this housing 45, the RFID chip is flush with the end of the accessory body 41 while being protected also by the accessory body.

First portion and second portion of the accessory body form an attachment portion.

6.1.3. Socket with Extension

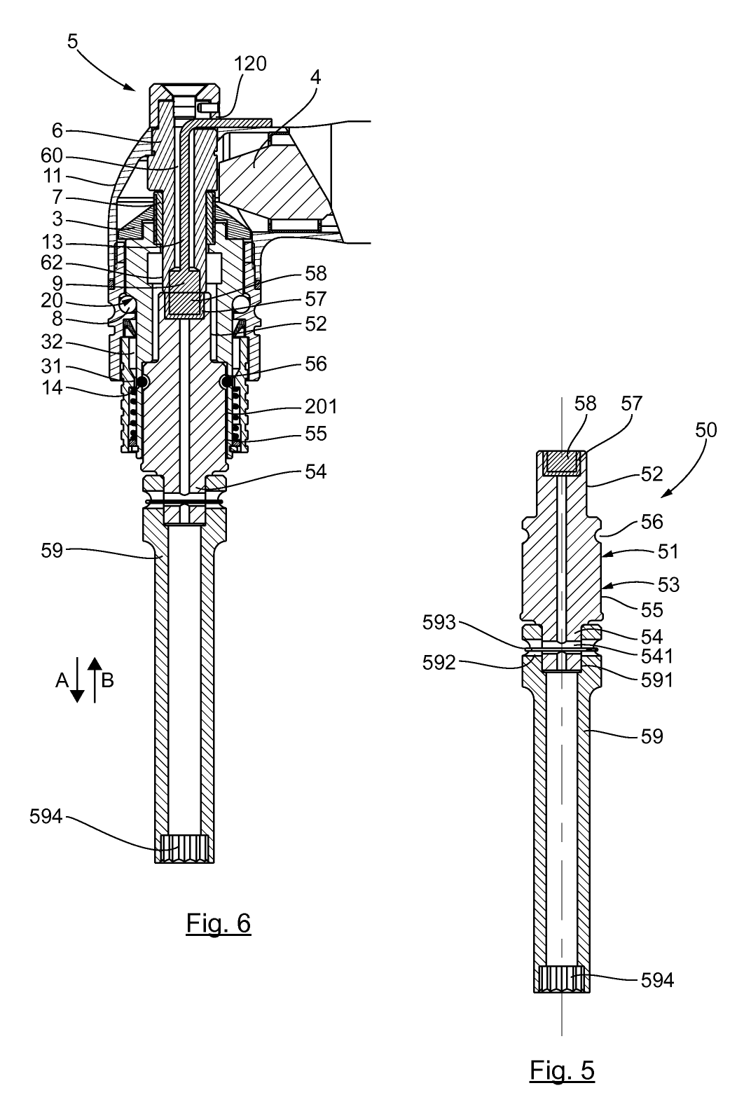

Referring to FIGS. 5 and 6, an example of a screw driving socket with extension or extension socket according to an exemplary embodiment is presented.

Such a screw driving socket with extension 50 comprises an accessory body 51 that is to be housed outside the hollow internal housing 200 of the output shaft 2.

This accessory body 51 comprises a first end portion 52, a central portion 53 and a second end portion 54.

The central portion 53 comprises a male peripheral hexagonal part 55 with a shape complementary to that of the female hexagonal recess 201 made in the output shaft 2. This central portion 53 also has a peripheral external groove 56 with a semi-circular section provided to house the beads 14.

The first end portion 52 comprises a housing 57 that houses an electronic tag such as for example an RFID chip 58. Thus housed in this housing 57, the RFID chip is flush with the end of the accessory body 51 while at the same time being also protected by the accessory body.

The second end portion 54 is crossed by a radial hole 541. An extension 59 has, at one of its ends, a housing 591 with a shape complementary to that of the second end portion 54 so as to be able to house this portion. It is crossed by a radial hole 592 designed to be situated in the extension of the hole 541 when the second end portion 54 cooperates with the housing 591 so that it is possible to insert a spike 593 into the holes 541, 592 to fixedly attach the lengthening piece 59 to the accessory body 51. At its other end, the extension 59 has a female recess with a hexagonal section 594 provided to cooperate with an element to be tightened.

The end portion 52 and the central portion 53 constitute an attachment portion.

6.1.4. Screw hold-and-drive socket

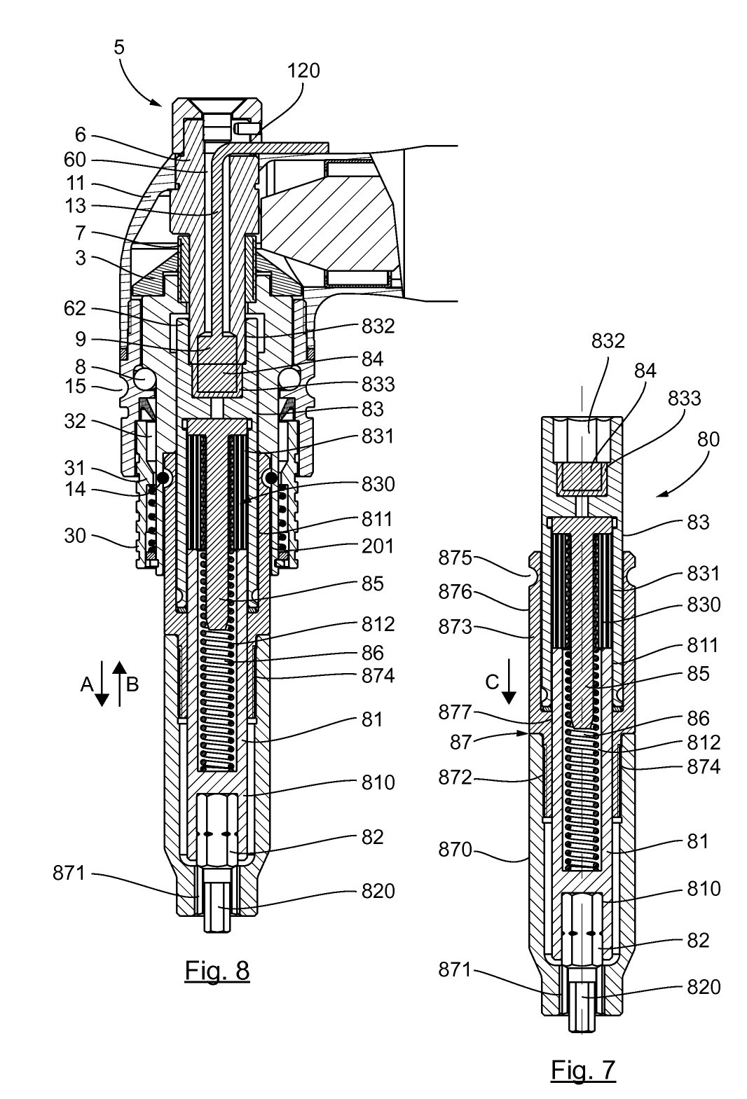

Referring to FIGS. 7 and 8, an example is provided of a hold-and-drive type device according to an exemplary embodiment.

Such a hold-and-drive device or unit 80 comprises a mechanism for blocking a screw in rotation.

This blocking mechanism comprises a first blocking element 81. This first blocking element 81 has a hexagonal female recess 810 at one of its ends. This recess 810 is provided to house a screwdriver tip 82 of a complementary shape, itself having a male hexagonal part 820 which is to cooperate with a housing of a complementary shape made in a screw. At its other end, the first blocking element comprises longitudinal grooves 811 forming a protrusion at its periphery. A bore hole 812 is made inside the first blocking element 81 from its end that has the grooves 811.

This blocking mechanism comprises a second blocking element 83. This element 83 has an inner bore hole 830 which extends from one of its ends, and inside which there are made grooves 831 with a shape complementary to the grooves 811 of the first blocking element 81. The first blocking element 81 can thus be inserted inside the bore hole 830 in making the grooves 811 and 831 cooperate so that the first and second blocking elements 81, 83 are rotationally linked and so that the first blocking element can get translated along the second blocking element. At the other one of its ends, the second blocking element 83 has a hexagonal female recess 832 of a shape complementary to that of the male hexagonal part 62 of the pin 6. This recess 832 is extended by a housing 833 within which an RFID tag 84 is placed. A guiding element 85 extends inside the bore holes 830 and 812. A compression spring 86 is mounted on the guiding element 85 between the first and second blocking element 81, 83. The first blocking element 81 is therefore mounted so as to be mobile in translation inside the second blocking element 83 against the effect of this spring 86 which tends to move it along the arrow C.

The hold-and-drive unit 80 comprises a driving element 87 for driving a nut. This driving element 87 has a first driving element 870. This driving element 870 comprises, at one of its ends, a hexagonal female recess 871 designed to cooperate with a nut and at the other of its ends it has a tapped portion 872. The driving element 87 comprises a second driving element 873 which has, at one of its ends, a threaded portion 874 with a shape complementary to that of the tapped portion 872 of the first driving element 870. The first and second driving elements can thus be fixedly attached to each other. At the other of its ends, the second driving element 873 has a semicircular-sectioned peripheral groove 875. This groove is designed to house the beads 14 in the locked position. A hexagonal male part 876 is made at the periphery of this end of the second driving element. This driving element has a shape complementary to that of the hexagonal female recess of the output shaft 2. A housing 877 is made inside the first and second driving elements to house the first and second blocking elements. The driving element 87 is thus mounted so as to be rotationally mobile on the first and second blocking elements.

The second blocking element 83 and the second driving element 873 constitute an attachment portion.

6.1.5. Crowfoot

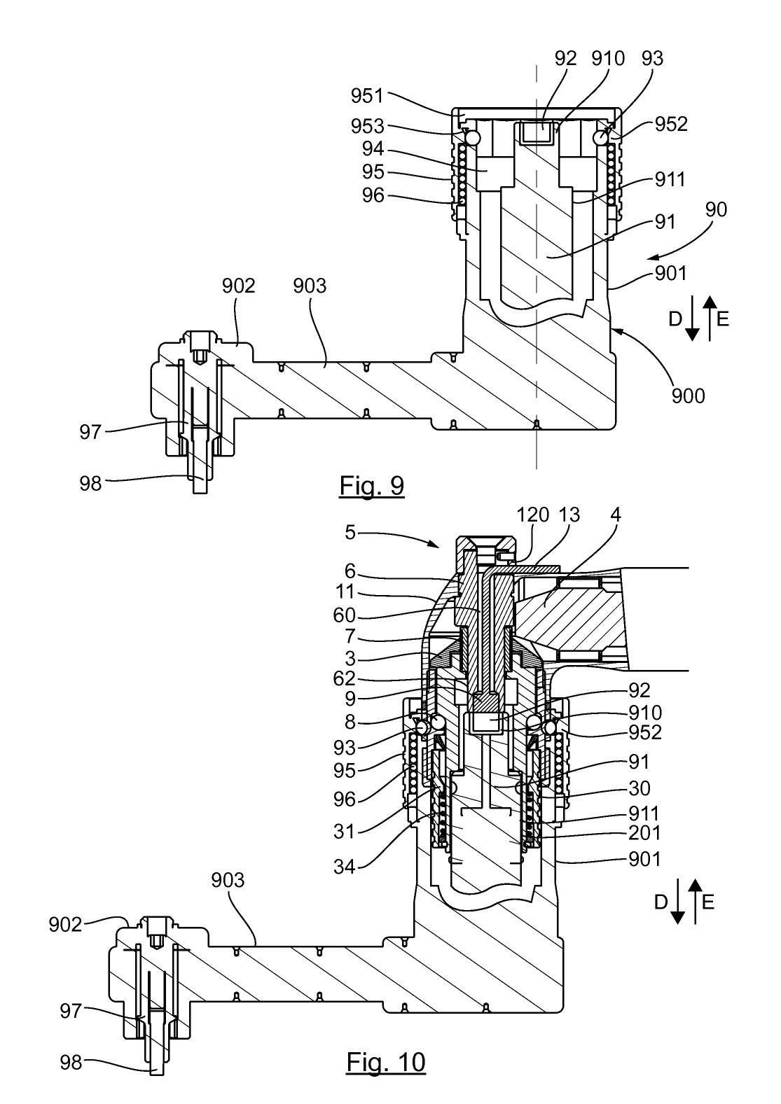

Referring to FIGS. 8 and 9, an example is presented of a crowfoot tool or unit according to an exemplary embodiment.

In general, a crowfoot unit is a screw driving accessory that comprises a train of parallel pinion gears used to move the rotational axis of the driving unit of the element to be screwed away from the axis of the motor. The purpose of this tool is to reach screws situated in a narrow space that is difficult or even incapable of direct access even with a classic screwdriver.

Such a crowfoot unit 90 comprises an accessory body 900. This accessory body comprises an attachment portion 901, a screw driving portion 902 itself connected by the connecting portion 903. The attachment portion 901 and screw driving portion 902 extend essentially in parallel to one another and essentially perpendicularly to the connecting portion 903.

The attachment portion 901 houses a drive shaft 91 (partially shown) that is mounted therein so as to be mobile in rotation. A spur gear (not shown) is rotationally linked to the lower end of the drive shaft 91. A housing 910, within which an RFID tag 92 is placed, is made at the other end of the drive shaft 91. A hexagonal male part 911 is made on the periphery of the drive shaft 91. This periphery has a shape complementary to that of the female hexagonal recess 201 of the output shaft 2.

Beads 93, fixedly joined to the accessory body 900, are mounted so as to be mobile in translation inside the wall of the upper end of the attachment portion 901 between:
a locking position in which they form a protrusion inside the hollow housing 94 made inside the attachment portion 901 to house the output shaft 2 and the end of the body portion 11 so as to be able to cooperate when the output shaft 2 and the end of the body portion 11 are housed in the hollow housing 94 with the groove 15 made at the end of the body portion 11: the crowfoot unit is thus fixedly attached to the body by the beads 93 which are housed in the groove 15, and
a release position in which they are at least partly concealed inside the peripheral wall of the attachment portion 901 so as to enable the beads 93 to be dislodged from the groove 15 in order to authorize the decoupling of the crowfoot unit from the screwdriver.

The Actuator is used to shift the beads 93 from one of their positions to the other. The actuator comprises a ring 95 that is mounted so as to be mobile in translation along the upper end of the attachment portion 901.

This ring 95 has a large-diameter internal portion 951 and a smaller-diameter internal portion 952 that are connected to one another by a truncated conical portion 953. This ring 95 is mobile relative to the attachment portion 901 between:
a locking position in which the small-diameter portion 952 acts on the beads 93 so as to push them into their locking position in which they protrude into the internal housing 94 if need be to cooperate with the groove 15 of the output shaft 2 to keep the crowfoot unit fixedly joined to the screwdriver, and
a release position attained when the ring 95 is translated along the arrow D, in which the small-diameter portion 952 does not face the beads 93 while the large-diameter portion 951 is situated in the extension of the beads 93, so much so that these beads can get retracted within the attachment portion 901 to occupy their release position thus allowing the uncoupling of the crowfoot unit.

A compression spring 96 interposed between the ring 95 and the attachment portion 901 tends to bring the ring 95 to its locking position in exerting a recall force on this ring along the arrow E.

The pinion gear fixedly joined to the lower end of the drive shaft 91 engages with the first pinion gear (not shown) of a cascade of pinion gears (not shown) mounted on parallel pins within the connection portion 903. The last of these pinion gears (not shown) is mounted on an output shaft 97 to which it is fixed in rotation. This output shaft 97 is mounted so as to be mobile in rotation in the screw driving portion 902. At its lower end, it has a screw driving element 98.

6.2. Operation

Two groups of screw driving accessories can be fixedly attached to the screwdriver:
screw driving socket type accessories, and
crowfoot type accessories.

6.2.1. Fixed Attachment of a Socket Type Accessory

i. Socket

The fixed attachment of a screw driving socket 40 to a screwdriver according to an exemplary embodiment is obtained as follows.

The ring 30 is shifted along the arrow A in its release position in which its small-diameter portion 31 no longer acts on the beads 14 which are situated in the prolongation of its wide-diameter position 32. The beads 14 are then free to retract within the peripheral wall of the output shaft 2. The beads can thus reach a position in which the diameter of the hollow internal housing 200 at the end of the beads turned towards this housing 200 is big enough to enable the insertion of the socket.

The accessory body 41 of the socket 40 is then inserted into the hollow internal housing 200 of the output shaft 2 in making the male hexagonal part 42 of the socket 40 cooperate with the female hexagonal recess 201 of the output shaft.

The output shaft 2 and the socket 40 are thus linked in rotation. During this insertion, the accessory body 41 acts on the beads 14 to place them in their release position.

The ring 30 is then released so that it is shifted along the arrow B under the effect of the spring 34 and thus brought into its locking position. Its small-diameter portion 31 is then situated so as to be facing the beads 14 on which it acts to place them in their locking position in which they cooperate with the groove 43 made on the periphery of the accessory body 41 of the socket 40. The socket 40 is thus blocked in translation inside the output shaft 2 along its longitudinal axis.

With the socket thus positioned, the RFID tag 46 is situated so as to be facing the reader 9 and in proximity to it. The command unit can thus recognize, by means of the reader and the RFID tag, the socket fixedly attached to the screwdriver and select the adapted screw driving strategy programmed in the screwdriver.

When the motor is implemented accordingly, the output shaft 2 is led rotationally via the transmission including especially the pair of bevel pinion gears. The socket 40 is driven rotationally via the output shaft 2.

To detach the socket 40, the ring 30 is shifted from its release position along the arrow A in which the beads 14 are free to retract into the peripheral wall of the output shaft 2. The socket is then shifted along the arrow A to be extracted from the hollow internal housing 201.

ii. Extension Socket

The fixed attachment of an extension socket 50 to a screwdriver according to an exemplary embodiment is obtained as follows.

The ring 30 is shifted along the arrow A in its release position in which its small-diameter portion 31 no longer acts on the beads 14 which are situated in the prolongation of its large-diameter portion 32. The beads 14 are then free to retract inside the peripheral wall of the output shaft 2. The beads can thus reach a position in which the diameter of the hollow internal housing 200 at the end of the beads pointing towards this housing is big enough to enable the insertion of the socket.

The accessory body 51 of the socket 50 is then inserted inside the hollow internal housing 200 of the output shaft 2 in making the male hexagonal part 55 of the socket 50 cooperate with the female hexagonal recess 201 of the output shaft. The output shaft 2 and the socket with extension socket 50 are thus linked in rotation. During this insertion, the accessory body 51 acts on the beads 14 to place them in their release position.

The ring 30 is then released so that it is shifted along the arrow B under the effect of the spring 34 and thus brought into its locking position. Its small-diameter portion 31 is then situated so as to be facing the beads 14 on which it acts in order to place them in their locking position in which they cooperate with the groove 56 made on the periphery of the accessory body 51 of the socket 50. The socket 50 is thus blocked in translation inside the output shaft 2 along its longitudinal axis.

With the extension socket 50 thus positioned, the RFID tag 58 is situated so as to be facing the reader 9 and in proximity to it. The command unit, by means of the reader and the RFID tag, can recognize the extension socket fixedly attached to the screwdriver and can select the adapted screw driving strategy programmed in the screwdriver.

When the motor is implemented accordingly, the output shaft 2 is driven in rotation via the transmission including especially the pair of bevel pinion gears. The extension socket 50 is driven in rotation via the output shaft 2.

To detach the extension socket 50, the ring 30 is shifted in its release position along to the arrow A in which the beads 14 are free to retract inside the peripheral wall of the output shaft 2. The extension socket can then be shifted along the arrow A to be extracted from the hollow internal housing 201.

iii. Hold-and-drive

The fixed attachment of a hold-and-drive unit 80 to a screwdriver according to an exemplary embodiment is obtained as follows.

The ring 30 is shifted along the arrow A in its release position in which its small-diameter portion 31 no longer acts on the beads 14 which are situated in the prolongation of its large-diameter portion 32. The beads 14 are then free to retract inside the peripheral wall of the output shaft 2. The beads can thus reach a position in which the diameter of the hollow internal housing 200 at the end of the beads turned towards it is big enough to enable the insertion of the hold-and-drive unit.

The hold-and-drive unit is then inserted into the hollow internal housing 200 of the output shaft 2 in making the male hexagonal part 62 of the pin 6 cooperate with the female hexagonal recess 832 and the male hexagonal part 876 cooperate with the female hexagonal recess 201 of the output shaft. The output shaft 2 and the driving element 87 are thus linked in rotation. The blocking elements 81 and 83 are thus blocked in rotation by the pin 6. During this insertion, the drive element 87 acts on the beads 14 to place them in their release position.

The ring 30 is then released so that it is shifted along the arrow B under the effect of the spring 34 and thus brought into its locking position. Its small-diameter portion 31 is then situated so as to be facing the beads 14 on which it acts in order to place them in their locking position in which they cooperate with the groove 875 made on the periphery of the second driving element 873. The hold-and-drive unit 50 is thus blocked in translation inside the output shaft 2 along its longitudinal axis

With the hold-and-drive unit 80 thus positioned, the RFID tag 84 is situated so as to be facing the reader 9 and in proximity to it. The command unit can thus, by means of the reader and the RFID tag, recognize the hold-and-drive unit fixedly attached to the screwdriver and select the adapted screw driving strategy programmed in the screwdriver.

When the motor is implemented accordingly, the output shaft 2 is driven in rotation via the transmission unit including especially the pair of bevel pinion gears. The drive element 87 is thus driven in rotation by the output shaft 2 while the blocking elements 81, 83 are kept immobile by the pin 6.

To detach the hold-and-drive unit 80, the ring 30 is shifted in its release position along the arrow A in which the beads 14 are free to retract inside the peripheral wall of the output shaft 2. The hold-and-drive unit can then be shifted along the arrow A to be extracted from the hollow internal housing 201.

6.2.2. Fixed Attachment of a Crowfoot Type Accessory

The fixed attachment of a crowfoot unit 90 to a screwdriver according to an exemplary embodiment is obtained as follows.

The ring 95 is shifted along the arrow D in its release position in which its small-diameter portion 82 no longer acts on the beads 93 which are in the prolongation of its large-diameter portion 951. The beads 93 are then free to retract inside the peripheral wall of the attachment portion 901. The beads can thus reach a position in which the diameter of the hollow internal housing 200 at the end of the beads turned towards this housing is big enough to enable the insertion of the body into the crowfoot unit.

The accessory body 900 of the crowfoot unit 90 is then brought close to the end 11 of the body of the screwdriver so as to insert its end inside the housing 94 in making the male hexagonal part 911 of the drive shaft 91 cooperate with the female hexagonal recess 201 of the output shaft 2. The output shaft 2 and the drive shaft 91 are thus linked in rotation.

The ring 95 is then released so that it is shifted along the arrow E under the effect of the spring 96 and thus brought into its locking position. Its small-diameter portion 952 is then facing the beads 93 on which it acts to place them in their locking position in which they cooperate with the groove 15 made on the periphery of the end 11 of the body of the screwdriver. The crowfoot unit 90 is thus blocked in translation inside the output shaft 2 along its longitudinal axis.

With the crowfoot unit thus positioned, the RFID tag 92 is facing the reader 9 and in proximity to it. The command unit can thus, by means of the reader and the RFID tag, recognize the crowfoot unit fixedly joined to the screwdriver and can select the adapted screw driving strategy programmed in the screwdriver.

When the motor is implemented, the output shaft 2 is driven in rotation via the transmission including especially the pair of bevel pinion gears. The driving shaft 91 is driven in rotation via the output shaft 2 and the output shaft 97 is driven in rotation via the driving shaft 91 and the cascade of pinion gears.

To detach the crowfoot unit 90, the ring 95 is shifted in its release position along the arrow D in which the beads 93 are free to retract inside the peripheral wall of the attachment portion 901. The crowfoot unit 90 can then be shifted along the arrow D to be extracted from the hollow internal housing 201.

It can be observed that when the first reversible fixed attachment is implemented, the second reversible fixed attachment is inactive, and vice versa.

6.3. Information Carried and Readable in the RFID Tag

The information carried and readable in the RFID tag can be restricted to a simple identifier which, once recognized by the command unit of the screwdriver, enables the activation of the screw driving strategy contained in the command unit and corresponding to the accessory.

Other pieces of information can be envisaged, especially:
the number of screwing cycles already achieved by the accessory and characterizing the state of wear and tear of the device. Depending on these cycles, the command unit of the screwdriver could prompt:
   an alert intended for the operator on the need for immediate or forthcoming maintenance on the accessory,
   a deactivation of the screwdriver.
a screw driving strategy proper to the accessory and replacing a screw driving strategy contained in the command unit of the screwdriver.
other items of information coming either from the supplier or from the company using the screw driving accessory, for example the reduction ratio or the efficiency of transmission in the case of a crowfoot unit.

The choice of the type of RFID tag will naturally be adapted to the volume of these items of information.

At least one embodiment of the disclosure provides a particularly robust technique that provides for the recognition of a screw driving accessory fixedly attached to a screwdriver by reading its identifier.

At least one embodiment, as a complement to reading the identifier of the screw driving accessory, provides for reading of information pertaining to a screw driving strategy specific to this accessory or pertaining to its maintenance or again to its own characteristics.

At least one embodiment provides a technique that enables the fixed attachment to one and the same screwdriver of accessories of different types, for example at certain times the attachment of a socket and at other times the attachment of a crowfoot type unit.

At least one embodiment provides a technique of this kind that is simple to implement and/or ergonomical and/or simple in design.

Although the present disclosure has been described with reference to one or more examples, workers skilled in the art will recognize that changes may be made in form and detail without departing from the scope of the disclosure and/or the appended claims.

1. Screw driving system comprising:
a screw driving device comprising a body at one end of which there is mounted an output shaft mounted so as to be mobile in rotation, said body housing a motor connected to said output shaft by a transmission,
at least one screw driving accessory configured to cooperate with said output shaft to be driven in rotation,
at least one reversible attachment for the reversible attachment of said at least one screw driving accessory to said screw driving device,
elements for recognizing said accessory when it is fixedly attached to said device via said means for reversible attachment, said elements for recognizing comprising an electronic tag reader fixedly attached to said device and an electronic tag fixedly attached to said accessory, said reader and said tag being positioned, when said accessory is fixedly attached to said device, in the axis of said output shaft, said reader being connected by at least one power supply and/or data transmission wire, said at least one wire extending in said device in the axis of said output shaft.

2. The screw driving system according to claim 1, wherein said body comprises a first body portion housing said motor and a second body portion housing said output shaft, said second body portion being traversed by at least one hole inside which there passes said at least one wire, said body and said hole being configured to enable said wire to extend outside said body along said first body portion.

3. The screw driving system according to claim 1, wherein said transmission comprises at least one first pinion gear and one second pinion gear engaged with each other, said second pinion gear being rotationally linked with said output shaft, said at least one wire extending through said second pinion gear.

4. The screw driving system according to claim 3, wherein said first pinion gear and said second pinion gear belong to the group comprising:
bevel type pinion gears;
parallel type pinion gears.

5. The screw driving system according to claim 3, wherein said device comprises a pin extending along the axis of rotation of said second pinion gear and passing through it, said pin being crossed by a passage inside which said at least one wire extends.

6. The screw driving system according to claim 5, wherein said pin is fixed relative to said body.

7. The screw driving system according to claim 6, wherein said reader is fixedly attached to said pin.

8. The screw driving system according to claim 1, wherein said output shaft comprises a hollow internal housing capable of receiving an attaching portion of said screw driving accessory, said reader extending on the border of said hollow internal housing in such a way that when said accessory is fixedly attached to said device and said accessory attaching portion is housed inside said hollow internal housing, said tag and said reader face each other.

9. The screw driving system according to claim 8, wherein said hollow internal housing has a shape complementary to the shape of said attaching portion of said screw driving accessory), said shapes being configured to provide for a rotational link of said output shaft with said screw driving accessory.

10. The screw driving system according to claim 1, wherein said reversible attachment comprises at least:
locking elements mobile between a locked position in which they cooperate with said screw driving accessory or with said device to keep said accessory and said device fixedly attached, and a release position in which they do not cooperate with said screw driving accessory or with said device so that said accessory and said device are no longer kept fixedly attached, and
an actuator for actuating said locking elements, said actuator being mobile between a locking position in which the actuator acts on said locking elements to place them in their locked position, and a release position in which said locking elements can take their release position.

11. The screw driving system according to claim 1, wherein said reversible attachment comprises:
a first reversible fixed attachment of a first group of at least one screw driving accessory, and
a second reversible fixed attachment of a second group of at least one screw driving device.

12. The screw driving system according to claim 11, wherein said first and second reversible fixed attachments are coaxial.

13. The screw driving system according to claim 1, wherein said electronic tag contains information belonging to the group consisting of:
the identifier of said screw driving accessory;
the parameters of the screw driving strategy associated with said screw driving accessory;
data relative to the maintenance of said screw driving accessory;
manufacturer's and/or user's data concerning the screw driving device and/or the screw driving accessory.

14. A screw driving device comprising:
a body at one end of which there is mounted an output shaft so as to be mobile in rotation, said body housing a motor connected to said output shaft by a transmission, and
an element for recognizing at least one screw driving accessory that is configured to cooperate with said output shaft to be driven in rotation, when fixedly attached to said device via a reversible attachment, said element comprising an electronic tag reader fixedly attached to said device and positioned to recognize an electronic tag fixedly attached to said accessory, said reader and said tag being positioned, when said accessory is fixedly attached to said device, in the axis of said output shaft, said reader being connected by at least one power supply and/or data transmission wire, said at least one wire extending in said device in the axis of said output shaft.

15. A screw driving accessory configured to cooperate and be driven in rotation with an output shaft of a screw driving device, the accessory comprising:
an electronic tag positioned such that when said accessory is fixedly attached to said device, in an axis of said output shaft, said tag is recognizable by an electronic tag reader attached to the device and positioned along the axis of the output shaft.
